(19) United States
(12) Patent Application Publication
(10) Pub. No.: US 2008/0126244 A1
(43) Pub. Date: May 29, 2008

(54) Loan application information routing system and method with real-time credit check and demographics augmentation

(75) Inventors: Scott M. Loving, Chesterfield, VA (US); Dinesh K. Prakashchand, Richmond, VA (US); Justin M. Harlow, Midlothian, VA (US); Mingshi Zhou, Richmond, VA (US); Loc Q. Do, Glen Allen, VA (US); Travis B. Weisleder, Richmond, VA (US)

Correspondence Address: JOHN S. PRATT, ESQ;KILPATRICK STOCKTON, LLP, 1100 PEACHTREE STREET, ATLANTA, GA, 30309, US

(73) Assignee: IFMG-IP, LLC, Richmond, VA (US)

(21) Appl. No.: 11/786,543

(22) Filed: Apr. 11, 2007

Related U.S. Application Data
(60) Provisional application No. 60/858,625, filed on Nov. 13, 2006.

(51) Int. Cl. G06Q 10/00; G06Q 40/00; G06Q 30/00

(52) U.S. Cl. 705/38; 705/1

(57) ABSTRACT

Loan application information routing systems and methods with real-time credit check and demographics augmentation are provided. Also provided are systems and methods for managing relationships with customers (e.g., initiating follow-up contacts) and interfacing with lenders.

### CROSS-REFERENCE TO RELATED APPLICATION

This claims priority to U.S. Provisional Patent Application No. 60/858,625, filed Nov. 13, 2006, which is hereby incorporated by reference herein in its entirety.

### FIELD OF THE INVENTION

Embodiments of the present invention relate generally to systems and methods for routing loan application information electronically and, more particularly, to loan application information routing systems and methods with real-time credit check and demographics augmentation. Also provided are systems and methods for managing relationships with customers and interfacing with lenders.

### BACKGROUND OF THE INVENTION

Statistics show that, due to their credit scores, over 80% of individuals who finance cars with a loan obtain indirect loans from a lender (e.g., bank, finance company, or credit union). With an indirect car loan, the lender requires the car to be purchased from an approved car dealership. Thus, traditionally employees of the car dealership generate all of the loan application paperwork and then send that information to the lender. Car dealership employees also run credit bureau reports for loan applicants, schedule follow-up appointments, and track sales performance of the dealership. This is a labor-intensive process that increases the overhead cost to the dealer and thus the purchase price of the car. The time commitment required by the car dealership to generate loan applications can also cause the dealer to turn away a customer prematurely if there is a question whether the customer will ultimately qualify for a loan. Individuals with less than perfect credit may also hesitate to apply for a car loan to avoid the unpleasant experience of having their loan application rejected.

In view of the foregoing, it would be desirable to provide systems and methods for routing loan applications electronically. It would also be desirable to provide systems and methods for managing relationships with customers.

### SUMMARY OF THE INVENTION

Embodiments of the present invention relate to systems and methods for routing loan application information (e.g., car loan application information) electronically. In some embodiments, the loan application information may be subject to a credit check, for example, in real time and/or prior to submitting at least a portion of the information to one or more car dealerships. Embodiments also provide that the loan application information may be augmented with demographics data. Customer relationship management (“CRM”) systems and methods are also provided for managing relationships with customers, including displaying loan application information received from the routing system, accessing and displaying full credit reports, scheduling in-person appointments, initiating follow-up contacts (e.g., via e-mail, physical mail, and/or telephonically), and submitting loan applications to lenders.

Aspects of the present invention provide a routing system that receives and processes leads from one or more affiliate entities (“affiliates”). As used herein, a lead includes information for a party that may be interested in purchasing an automobile and/or securing a loan. The affiliates may generate different types of leads such as, for example, internet leads, telephonic leads, and leads generated from walk-in customers. Internet leads may be generated when parties enter personal information and optionally information regarding automobile(s) of interest (e.g., make(s), model(s), option(s)) into data fields at www.CarLoan.com or other websites affiliated with the routing system. Telephonic leads may be generated when parties telephone human operators and/or automated systems (e.g., at 1-800-CAR-LOAN) affiliated with the routing system that place information received from the parties into electronic form. Leads may also be generated by the affiliates based on in-person meetings with customers. Other methods are possible, such as a combination of the above methods and these examples should not be viewed as the only possible examples.

In some embodiments, the routing system may subject a lead to a credit check to determine whether to accept or reject the lead and/or to select particular car dealer(s) to which the routing system provides the lead. For example, the routing system may receive a lead through a HyperText Transfer Protocol (“HTTP”) connection with an affiliate, and either during the pendency of that connection or subsequent to its termination the routing system may transmit at least a portion of the information from the lead to one or more credit bureaus (e.g., Experian, TransUnion, Equifax). In turn, the one or more credit bureaus may perform a credit check based on the information and may provide the routing system with an indication regarding the party's credit-worthiness. For example, the credit bureau(s) may transmit a credit grade (e.g., A, B, C, D, etc.) to the routing system, where each grade represents a range of credit scores. Advantageously, the credit check may be a “soft” credit check that does not adversely affect the loan applicant's credit score. Based at least in part on the credit grade, the routing system may determine whether to accept or reject the lead from the affiliate and/or may select one or more car dealerships to which to transmit the lead. In some embodiments, the routing system may send a notification to the affiliate indicating whether the lead is accepted or rejected, either via the same HTTP connection with the affiliate, upon establishing a new HTTP connection with the affiliate, or by another approach (e.g., e-mail).

In some embodiments, the routing system may include a database of information regarding car dealerships that are eligible to receive leads electronically from the routing system. The database may store parameters (e.g., preferences of car dealerships) that can be used to determine which dealer(s) will receive a given lead. For example, each lead may be associated with a zip code (e.g., the zip code of a prospective loan applicant's residence address), and only car dealerships associated with that zip code as indicated by data stored in the database may be eligible to receive the lead. Alternatively or additionally, the routing system may store one or more lead caps or targets (e.g., daily cap, monthly cap, etc.) for each car dealer and only dealers who have not exceeded those caps or who have exceeded the caps by less than a predetermined amount may be eligible to receive the lead. In the event that multiple car dealerships meet specified eligibility criteria, the routing system may provide the lead to the dealer furthest from meeting its monthly lead cap or target (e.g., as indicated by the ratio of offers received to the target or cap number of leads). A lead count for the dealer may be incremented in the database each time the dealer is assigned a lead. System notifications (e.g., e-mails) may be sent to the car dealership and/or routing system administration when the car dealership has reached, or is approaching, a lead cap or target. Alternatively or additionally, when multiple car dealers are eligible to receive a lead, other qualifications may be used to determine which dealership receives the lead. For example, the car dealership that affiliated with the routing system first in time or that pays a premium to receive leads in case of a tie may receive the lead. In some embodiments, the routing system may process leads of multiple types (e.g., internet, telephone, walk-in) and from multiple affiliates (with each unique type/affiliate pair being referred to as a “program”) and each car dealership may select the lead types, affiliates, and/or programs for which it will accept (or reject) leads. The routing system may automatically adjust the allocation of eligible lead types, affiliates, and/or programs for a dealer based on, for example, how close the dealer is to one or more lead caps or targets.

In some embodiments, the routing system may augment leads with demographics data for the party associated with the lead (e.g., title, surname, gender, age, birth date, marital status, education level, occupation code, number of children, dwelling type, household income, length of residence, renter status, homeowner status, and/or home value). The routing system may receive the demographics data, for example, from the credit bureau(s) during the same transaction in which the routing system receives the aforementioned credit grades. For example, a credit bureau may store or otherwise have access to demographics data for multiple parties. Based on address data for the party received from the routing system, the credit bureau may access and return the demographics data for the party by comparing the received address data with address data stored by or otherwise accessible to the credit bureau. Alternatively or additionally, the credit bureau may access and provide demographics data for the party by performing a reverse phone number lookup on a phone number received from the routing system. Such demographics data may be useful to the car dealership in determining, for example, the types of cars and/or offers that may be of interest to the party.

Still another aspect provides a customer relationship management (“CRM”) tool that manages relationships between car dealerships and their customers. The CRM tool may be implemented at the car dealership, remotely (e.g., as part of the routing system), or both in a distributed arrangement. For example, a portion of the CRM tool implemented at the car dealership by suitable hardware, software, or both (sometimes referred to herein as “DOLLAR”) may communicate with the routing system and may generate displays of information regarding current leads, including leads received from the routing system and/or leads generated by other sources such as walk-in customers. In some embodiments, the information displays may include credit grades that result from the aforementioned credit checks. Alternatively or additionally, the CRM tool may communicate with one or more credit bureaus to provide employees of the car dealership with access to full credit reports for the parties corresponding to the leads. Since accessing a customer's full credit report can adversely affect the customer's credit score, such access may be provided only when the car dealership has received express authorization from the customer (e.g., a party selecting an option at www.CarLoan.com authorizing car dealer(s) that receive the party's lead to access full credit report(s)). Alternatively or additionally, DOLLAR may allow the car dealership to submit loan applications to one or more lenders, where the loan applications may include at least a portion of the information received from the routing system and/or generated from walk-in customers of the dealership.

In some embodiments, a portion of the CRM tool implemented remotely relative to the car dealership by suitable hardware, software, or both (sometimes referred to herein as Follow-Up Every Lead or “FUEL”) may manage follow-up contacts with customers of the car dealership. For example, when the routing system receives a new lead from an affiliate, the routing system may notify the CRM tool FUEL of the new lead. Alternatively or additionally, DOLLAR may notify FUEL of a new lead when DOLLAR receives the lead, for example, from the routing system or based on an in-person meeting between an employee of the car dealership and a walk-in customer. Once notified of the lead, FUEL may initiate follow-up contacts (e.g., e-mails, physical mail, telephone calls) to the customer according to a predetermined, event-driven methodology. Advantageously, this may assist the dealership to build and maintain good rapport with customers while relieving the dealership of the requisite workload. The sequence of follow-up contacts may be designed to guide the customer through the buying process (e.g., initial contact, scheduling an in-person appointment, and/or follow-up after first visit or missed appointment). In some embodiments, if the dealership updates the status of a lead in DOLLAR (e.g., identifying the lead as a completed transaction), DOLLAR may notify FUEL of the update and in response FUEL may adjust the sequence of follow-up contacts accordingly (e.g., thank you for your purchase). Advantageously, this may prevent the customer from receiving mixed messages about his or her buying experience.

Accordingly, an aspect of the present invention provides a method and system for processing loan application information electronically. A routing engine may be provided that is configured to receive a lead electronically, where the lead includes information relating to a party seeking to purchase an automobile with a loan. Additionally, the routing engine may be configured to submit at least a portion of the information from the lead to a credit checking system for a credit check, receive credit information regarding the party in response to the submitting, and based at least in part on the credit information, route the lead to a selected destination.

In another aspect, methods and systems are provided for processing leads electronically, in which a routing engine may be configured to receive a lead electronically, submit a request for demographics information relating to the party, receive the demographics information in response to the submitted request, augment the lead with at least a portion of the received demographics information, and route the augmented lead to a relevant destination.

In yet another aspect, methods and systems are provided for managing follow-up contacts with customers. A database may be provided that includes associations between events within a sales cycle and follow-up contacts. A customer relationship management tool may be provided that is configured to receive information identifying a customer of a car dealership and a status of that customer and, when the customer's status matches an event within the sales cycle, trigger a follow-up contact to the customer on behalf of the car dealership.

The foregoing and other features, aspects, and advantages of the present invention will be more apparent from the following detailed description, which illustrates exemplary embodiments of the present invention.

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1 is a block diagram of a system for routing loan application information electronically and for managing relationships with customers (e.g., prospective or current loan applicants) in accordance with an embodiment of the present invention;

FIG. 2 is a flowchart of illustrative stages involved in receiving and processing loan application information in accordance with an embodiment of the present invention;

FIG. 3 is a flowchart of illustrative stages involved in adjusting the affiliates from which a car dealership is eligible to receive leads according to a lead ratio in accordance with an embodiment of the present invention; and

FIG. 4 is a flowchart of illustrative stages involved in initiating follow-up contacts with customers according to a predetermined, event-driven methodology in accordance with an embodiment of the present invention.

### DETAILED DESCRIPTION OF THE INVENTION

The following description focuses on an illustrative use of the present invention to routing information regarding car loan applications electronically. In other embodiments, aspects of the present invention related to (for example) real-time credit checking, demographics augmentation, and/or managing customer relationships including generating follow-up contacts may be applied to information regarding home mortgage applications, debt consolidation services, and/or in other contexts.

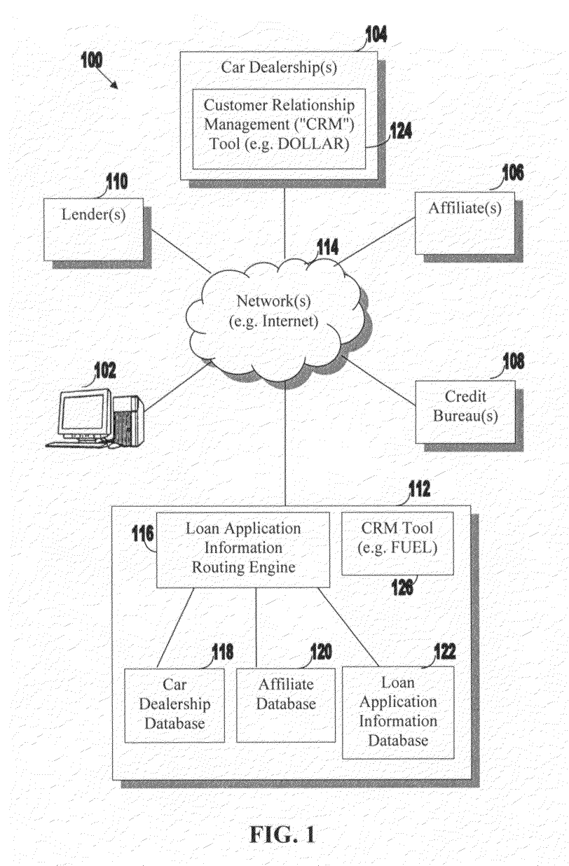

FIG. 1 is a block diagram of a system 100 for routing car loan application information electronically and for managing relationships with customers (e.g., prospective or current loan applicants) in accordance with an embodiment of the present invention. System 100 includes user computer(s) 102, car dealership(s) 104, affiliate(s) 106 responsible for collecting information from parties that may be interested in purchasing an automobile and/or securing a loan, credit bureau(s) 108, lender(s) 110, and loan application information routing system 112, all of which communicate over a network (e.g., internet) or networks 114. Each of user computer(s) 102, car dealership(s) 104, affiliate(s) 106, credit bureau(s) 108, lender(s) 110, and loan application information routing system 112 may be in electrical communication with network(s) 114 via a suitable communications capability such as, for example, a cable or satellite connection, a local area network (“LAN”), any other suitable wired, wireless, or optical connection, or a combination thereof. Loan application information routing system 112 may include routing engine 116, database 118 including information regarding various car dealerships, database 120 including information regarding various affiliates, and database 122 including loan application information for various leads received by system 112. Each car dealership 104 may include customer relationship management (“CRM”) tool 124 (sometimes referred to herein DOLLAR) for interfacing with routing engine 116, submitting loan applications to lenders, and/or initiating follow-up contacts with customers. Alternatively or additionally, some or all of the functions related to initiating follow-up contacts with customers may be performed by CRM tool 126 (sometimes referred to herein as FUEL).

User computer 102 may include any suitable computing equipment for allowing an associated end user to enter and submit information, for example, to affiliate 106 for processing by system 100. Such information may include personal information and/or information regarding make(s), model(s), and/or option(s) of one or more automobiles. User computer 102 may also facilitate the receipt and display of response(s) regarding the submitted loan application information and/or other functions such as scheduling in-person appointments with car dealership(s) 104. For example, as shown in FIG. 1, user computer 102 may be a desktop computer. In other examples, user computer 102 may be a laptop computer, telephone (e.g., mobile phone), personal digital assistant (“PDA”), BlackBerry device, or any other suitable computing device. User computer 102 may have a web browser (e.g., Internet Explorer, Netscape Navigator, Mozilla Firefox) operating thereon for facilitating communications over network(s) 114. For example, the web browser may access and read marked-up document(s) (e.g., HTML documents) from affiliate 106 and then translate and render those documents into pages viewable by an end user of user computer 102. These pages may include data entry field(s) (e.g., pull-down menus with selectable options and/or open-ended response fields) into which the end user can enter and submit personal information, such as name, address, Social Security Number, telephone number, e-mail address, income information, job title, employer information, automobile make(s), model(s), and/or option(s), and/or any other information that may be necessary or useful, for example, for system 100 to determine the end user's credit worthiness, to generate and process a car loan application for the end user, and/or to select appropriate car dealership(s) 104 to which to forward the end-user's information. Typically, system 100 will include multiple user computers 102 and/or multiple affiliates 106 although only one user computer 102 and one affiliate 106 are shown in FIG. 1 to avoid overcomplicating the drawing.

In some embodiments, affiliate 106 may be a publisher of web page(s) over internet 114. For example, one affiliate may be the computing system responsible for publishing one or more web pages viewable at http://www.CarLoan.com. Another affiliate may be the computing system responsible for publishing web page(s) viewable at http://www.AutoLoan.com. Each of these affiliates 106 may include one or more servers for receiving and responding to requests from user computers 102 for access to the page(s), and for processing information entered into the pages by end users. End users of user computers 102 may request access to a given page, for example, by typing the Universal Resource Locator (“URL”) for that page into an address region of a browser or by selecting a link for the page from a list of search results.

In some embodiments, affiliate 106 may receive information for parties desirous of purchasing an automobile and/or securing a loan by telephone, electronic mail, physical mail, or by other means. For example, affiliate 106 may include an automated system, a live operator, or both that receive telephone calls (e.g., calls to 1-800-CAR-LOAN) from a party and that collect the information that forms the basis for a lead.

Regardless of the manner in which affiliate 106 receives the information for the leads, affiliate 106 may submit the leads (including at least a portion of the received information and/or other information such as an identifier for the affiliate or program) electronically to routing system 112 via network 114. In some embodiments, affiliate 106 may be a third party that receives payment from routing system 112 for leads provided by affiliate 106 to system 112. In some embodiments, affiliate 106 may be owned and operated by the same entity that owns and operates routing system 112, in which case the affiliate may be referred to as an “organic” affiliate.

Affiliate 106 may submit leads to routing system 112 using any suitable approach. In one embodiment, one or more servers of routing engine 116 may provide a Secure Socket Layer (SSL) post page to which affiliate(s) 106 can post XML documents that include the leads. The XML documents may be subject to validation by routing engine 116 to ensure compliance with various formal and/or substantive requirements (e.g., value ranges, income levels, conditional field validations, required field validations). Other approaches for submitting leads to routing engine 116 are of course possible, and will be apparent to one of ordinary skill in the art in view of the teachings set forth herein. For example, when affiliate 106 is an organic affiliate, affiliate 106 and routing system 112 may be located within the same facility such that affiliate 106 can provide the leads to routing engine 116 via a local area network (LAN), a serial connection, or any other suitable wired, wireless, or optical communications capability. In some embodiments, routing engine 116 may perform less, if any, validation on leads received from organic affiliate(s).

Routing engine 116 may include any suitable hardware, software, or both for receiving and processing the leads received by system 112 from affiliate(s) 106. In some embodiments, such processing may include validating the leads. For example, routing engine 116 may reject (e.g., discard) a lead that fails the validation and/or may send a response to the affiliate 106 indicating the rejection and optionally identifying one or more deficiencies with the lead (e.g., missing or improper fields or offensive language). Leads that pass the validation, or for which no validation is performed, may be further processed by routing engine 116. Such processing may include storing at least a portion of the information in database 122, reformatting (if any) the information, submitting at least a portion of the information to credit bureau(s) 108 for a credit inquiry (e.g., soft credit inquiry) and/or demographics augmentation, comparing the information to information stored in databases 118, 120, and/or 122 (e.g., in order to select one or more car dealerships 104), and/or transmitting the information to car dealership(s) 104. For example, routing engine 116 may communicate electronically with the credit bureau Trans Union® (including the CRONUS on-line credit reporting database) via a TCP/IP interface and according to a specified protocol. In some embodiments, routing engine 1116 may generate displays of information for display to an administrator/user of system 112. Such information displays may be at least partially interactive to allow the administrator to view and/or modify the contents of databases 118, 120, and/or 122 such as, for example, settings associated with car dealership(s) 104 and/or affiliate(s) 106.

Database 118 may include information regarding car dealership(s) 104 including zip code(s) in which the car dealerships are located and/or otherwise affiliated, an indication of the relative order in which the dealerships became associated with routing system 112, account information such as balance due, and/or dealer preferences. For example, the preferences for a particular car dealership 104 may indicate whether that dealer can receive credit information and/or augmented demographics information, the credit bureau(s) from which the credit and/or demographics information can be obtained, particular credit ranges, scores, or grades of individuals for which the dealer will accept leads, affiliates from which the car dealerships will or will not accept leads, types of leads the dealer will accept (e.g., internet leads, telephonic leads, walk-in leads), programs in which the dealer is enrolled, and/or maximum quantities of leads the dealer can receive within given timeframe(s). Database 118 may also include lead counts indicating the actual quantities of leads that system 112 has provided to the car dealership(s) 104 within certain timeframe(s). In some embodiments, assignment of zip code(s) to car dealership(s) 104 may be performed manually by an administrator of system 112 via a zip code management page accessible via a suitable graphical user interface (e.g., intranet). In some embodiments, individual zip codes may be assigned to multiple dealerships, and each dealership may be associated with one or more zip codes.

Database 120 may include information regarding affiliate(s) 106 including a quantity of leads received by routing system 112 from each affiliate, quantities of such leads accepted and/or rejected by system 112, account balances including consideration (monetary or otherwise, if any) owed to the affiliates, and/or affiliate preferences. For example, the preferences for a particular affiliate 106 may indicate whether leads provided by that affiliate can be subject to credit inquiries and/or demographics augmentation by routing engine 116 and/or the credit bureau(s) 108 from which the credit and/or demographics information can be obtained.

Database 122 may include at least a portion of the information received by system 112 from affiliate(s) 106 such as name, address, Social Security Number, telephone number, e-mail address, income information, job title, employer information, and/or other information (e.g., other personal information and/or information identifying automobiles of interest to the party submitting the information). Alternatively or additionally, database 122 may include at least a portion of the information received by system 112 from credit bureau(s) 108 (e.g., credit grades and/or demographics information). Databases 118, 120, and 122 are only illustrative and any other suitable memory may be provided for storing information from routing system 112. For example, a single database may be provided within system 112 that combines the functions of databases 118, 120, and 122.

Leads and/or other information (e.g., scheduling information identifying appointments with prospective loan applicants) provided by system 112 to car dealership 104 may be received and processed by CRM tool 124. CRM tool 124 may include any suitable hardware, software, or both for receiving the information, storing the information in memory, assigning new leads to particular sales groups or representatives, and/or generating information displays for display to users (e.g., employees) at car dealership 104 (e.g., displays that issue alerts when new leads are received). The displays may be at least partially interactive to allow authorized employee(s) of car dealership 104 to perform interactive functions such as modifying or updating scheduling information (e.g., to indicate whether a scheduled meeting with a party occurred and/or an outcome of that meeting), entering loan application information for walk-in customers, submitting loan applications to lenders, and/or updating settings and/or preferences for the car dealership (e.g., to modify the dealership's enrollment in program(s) of system 112). In some embodiments, CRM tool 124 and routing system 112 may be in two-way communication such that CRM tool 124 can transmit information such as, for example, car dealership preferences to routing engine 116 and/or updated scheduling information to CRM tool 126 (e.g., directly or via routing engine 116).

CRM tool 126 may include any suitable hardware, software, or both for initiating follow-up contacts (e.g., e-mails, direct physical mail, and/or telephone calls) with customers of car dealership(s) 104. CRM tool 126 may initiate the follow-up contacts automatically according to a predetermined, event-driven methodology. In some embodiments, enrollment by car dealership(s) 104 to receive services provided by CRM tool 126 may be optional, and may be indicated by information stored in database 118. Examples of events that may trigger CRM tool 126 to initiate follow-up contacts with customers include the receipt of a new lead by system 112, the scheduling, completion, cancellation of and/or failure to attend an in-person appointment with a representative of car dealership 104, approval for loan(s) with one or more lenders 110, and/or the closing of an automobile sale. Alternatively or additionally, CRM tool 126 may initiate follow-up contacts at fixed time periods (e.g., 1, 5, 10, or 30 days) after these and other events. For example, in response to CRM tool 126 determining that 5 days have passed since the receipt of a new lead and that no additional contacts have been received from the party within that time, CRM tool 126 may transmit an electronic notification (e.g., e-mail or pop-up window) to a live operator affiliated with routing system 112 that prompts the operator to place a telephone call to the individual. In other embodiments, CRM tool 126 may dial the party's telephone number automatically. CRM tool 126 may provide the operator with a script (e.g., in one or more information displays) for the operator to use, for example, to encourage the party to schedule an in-person appointment with a representative of car dealership 104 (e.g., the same car dealership to which routing engine 116 previously assigned and transmitted the lead). When CRM tool 126 initiates electronic or physical mailings on behalf of car dealership 104, CRM tool 126 may cause the mailings to be branded with graphic logos and/or other information specific to car dealership 104. For example, such dealership-specific information may be stored in database 118, which may be accessible to CRM tool 126.

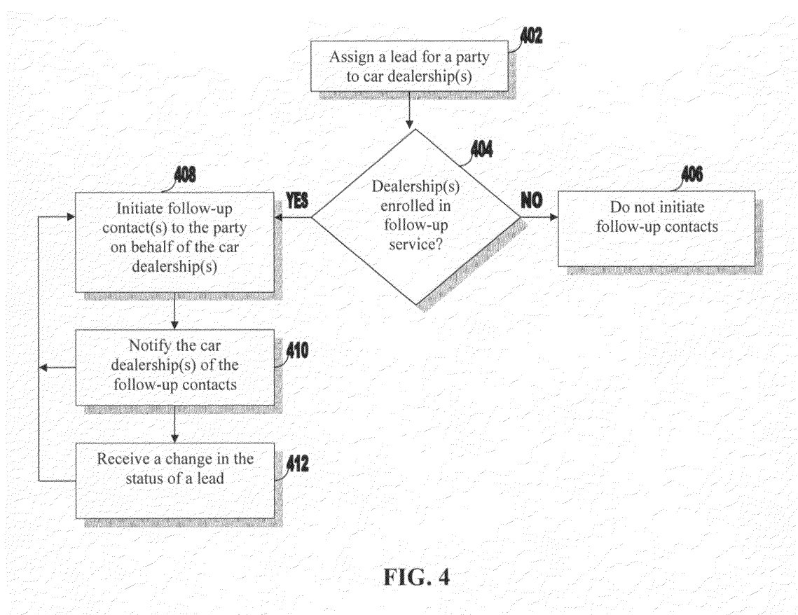

In some embodiments, CRM tool 124 may provide CRM tool 126 with status information indicating the status of a particular lead (e.g., a change in status), and in response CRM tool 126 may adjust (e.g., advance) the position of that lead within a progression of follow-up contacts. Advantageously, this may prevent CRM tool 126 from providing the party with mixed messages about the party's buying experience (e.g., the party receiving a message to schedule an initial appointment with a car dealership after such an appointment has already occurred). For example, if a representative at car dealership 104 provides CRM tool 124 with information indicating that a party has missed an in-person appointment (e.g., by entering information into display(s) generated by CRM tool 124), CRM tool 124 may transmit that information to CRM tool 126 automatically (e.g., immediately, hourly, daily, etc.) or according to any other suitable approach (e.g., in response to requests from CRM tool 126). In turn, CRM tool 126 may store the status information and trigger appropriate follow-up contacts (if any) to the party (e.g., a “sorry we missed you” e-mail and/or physical mail message). In some embodiments, e-mail messages triggered by CRM tool 126 may be sent to the party from one or more servers of CRM tool 126 (or other servers of system 112) or from third-party servers (e.g., Cheetahmail (http://www.cheetahmail.com), which is a third-party e-mail solution from Experian) in response to the third party's servers receiving triggering information, for example, from CRM tool 124 or CRM tool 126. Additional details regarding initiating follow-up contacts with customers are described below in connection with FIG. 4.

In some embodiments, CRM tool 124 may submit loan applications to one or more lenders 110 based at least in part on leads (with or without augmented demographics data) received by CRM tool 124 from routing system 112 and/or leads generated by car dealership 104 from walk-in customers. In some embodiments, CRM tool 124 may submit the loan application(s) to lender(s) 110 directly or, alternatively, via integration with the commercially-available DealerTrack® software. For example, if a car dealership 104 implements both CRM tool 124 and DealerTrack, CRM tool 124 may submit loan application information and/or selection(s) of lender(s) 110 to the DealerTrack software electronically, and the DealerTrack software may transmit at least a portion of the loan application information and/or other information to the selected lenders. In turn, lender(s) 110 may return loan application decision(s) (e.g., accept, reject, information regarding the proposed terms of the loan, and/or information identifying reason(s) for accepting or rejecting the application) either directly to CRM tool 124 or, alternatively, to the DealerTrack software which then provides the loan application decisions to CRM tool 124. CRM tool 124 may display information regarding the loan application decisions to authorized user(s) at car dealership 104 in one or more information displays.

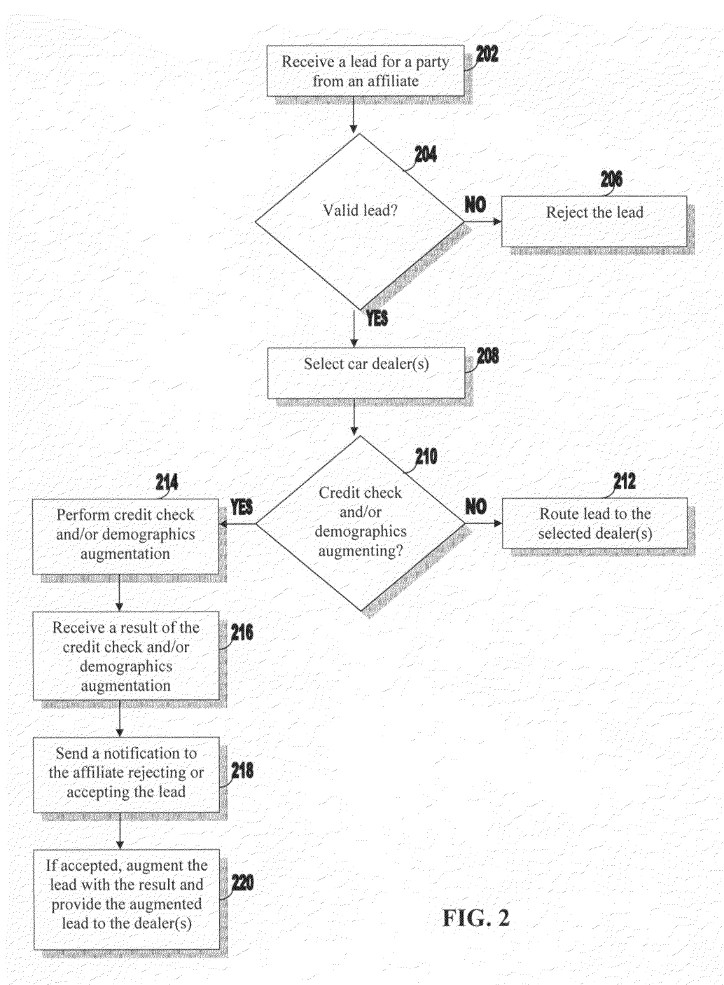

FIG. 2 is a flowchart of illustrative stages involved in receiving and processing loan application information in accordance with an embodiment of the present invention. At stage 202, a lead may be received that includes information associated with a party that may be interested in purchasing an automobile and/or securing a loan. For example, routing system 112 may receive a lead posted to a secure web server by affiliate 106. The lead may include personal information for the party (e.g., name and address) and/or information identifying automobile(s) of interest to the party.

At stage 204, the lead may be validated for compliance with one or more formal and/or substantive requirements. For example, leads received by routing system 112 may be transferred to a postcontroller module of routing engine 116 for initial processing. The postcontroller may save the loan application information in database 122. In some embodiments, the postcontroller may validate the lead against one or more acceptance guidelines for the affiliate 106, which guideline(s) may be set forth in an Affiliate Validation Matrix and/or Program Matrix stored by system 112 (e.g., in database 120). For example, these guidelines may specify the requirement for an active affiliate check (e.g., to confirm that the affiliate is authorized to communicate with system 112), income check, duplicate lead check (e.g., to confirm that the lead is not duplicative of a lead previously received/processed by system 112), zip code check, profanity check (e.g., to confirm the lead does not include profanity), address recognition check, and/or other application quality checks. At stage 206, if it is determined that the lead is invalid, the lead may be rejected. For example, routing system 112 may transmit a rejection of the lead to affiliate 106.

If the lead is valid, at stage 208 one or more car dealerships may be selected as eligible to receive the lead. For example, routing engine 116 may determine whether any car dealerships actively affiliated with system 112 are located in or otherwise associated with a zip code of the lead (e.g., a zip code in a prospective loan applicant's home address). If the determination is affirmative, routing engine 116 may select those car dealership(s) as eligible to receive the lead. If the determination is negative, routing engine 116 may reject the lead. Alternatively or additionally, routing engine 116 may determine whether the lead includes a dealer-specific approval code or a specific Dealer Identification Number. If either of these items exist, routing engine 116 may route the loan application information to the specified dealership (e.g., without any further processing by system 112).

In some embodiments, stage 208 may include determining whether one or more car dealerships (e.g., the car dealership(s) associated with a given zip code) are at their daily or monthly caps or targets. A monthly cap may be a limit on the number of leads a dealer can receive in one month. A monthly target may be a goal for the number of applications a dealer can receive in one month. If a car dealership's cap or target is exceeded, that dealership may be excluded from the list of car dealers eligible to receive the lead. For example, if assigning a lead to a dealer causes the dealer to have a monthly lead cap ratio in excess 0.9, 0.95 or 1.0, routing engine 116 may generate and send notifications (e.g., e-mails) to administrators of system 112 and/or car dealership 104.

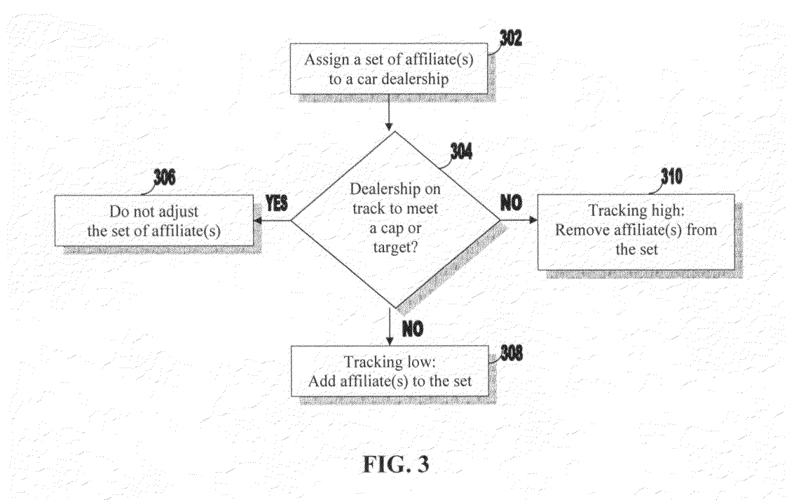

In some embodiments, the selection of car dealership(s) 104 at stage 208 may be based at least in part on lead ratio(s) for the dealers. A dealer's lead ratio may be the number of leads the dealer has received to date during a current period of time (e.g., month), divided by either the dealer's monthly cap or monthly target, whichever is higher. For example, stage 208 may involve routing engine 116 selecting the one or more dealer(s) with the lowest lead ratios. In case of a tie, routing engine 116 may select the dealer(s) with the lowest dealer ID(s), which may indicate the relative order in time in which the dealers affiliated with routing system 112. In some embodiments, if one or more of a dealer's monthly cap, monthly target, or assigned zip codes changes during a given month, routing engine 116 may automatically adjust the dealer's lead ratio in relation to the lead ratios of any other dealers that share the same zip code(s) to prevent bias in the dealer selection process. When routing engine 116 provides a lead to car dealership 104, a lead count for that dealership may be incremented by 1 within database 118. Additional details regarding selecting car dealership(s) to receive leads are described below in connection with FIG. 3.

At stage 210, a determination is made whether to subject the lead to a credit check and/or demographics augmentation. For example, routing engine 116 may determine whether leads received from affiliates 106 are eligible for one or more of a real-time marketing (“RTM”) check and/or credit pre-screen (e.g., from TransUnion and/or Experian). In some embodiments, the determination at stage 210 may be based at least in part on dealership-specific and/or affiliate-specific settings (e.g., stored in databases 118 and 120).

With respect to credit pre-screening, routing engine 116 may provide an administrator of system 112 with access to a page (e.g., program administration page or affiliate administration page) from which the administrator can set program-specific and/or affiliate-specific options related to credit pre-screening. For example, checking a box next to a program name may cause leads received for that program eligible to receive credit pre-screens if it is also determined that the dealership(s) selected at stage 208 are enrolled in credit pre-screening. In one embodiment, if the selected dealership(s) 104 are enrolled in credit pre-screening and TransUnion Promotional Credit Inquiry (“PCI”) is selected, a TransUnion pre-screen is performed on incoming leads for the dealer(s). In another embodiment, if the selected dealer(s) 104 are enrolled in credit pre-screening and Experian Instant Pre-Screen (“IPS”) is selected, an Experian credit pre-screen is performed on incoming leads for the dealer(s).

In some embodiments, routing engine 116 may provide an administrator of system 112 with access to one or more pages from which the administrator can set dealer-specific options related to credit pre-screening. Alternatively or additionally, a user at car dealership 104 may be authorized to set options related to credit pre-screening via one or more information displays (e.g., displays generated by routing engine 116 or CRM tool 124). For example, a program in which dealer 104 is enrolled may become eligible for credit pre-screening when a Credit Enrollment Status checkbox is selected for the program on a dealer-specific page. Alternatively or additionally, selecting an option associated with a program (e.g., “edit”) may open the settings for that program, from which the type of pre-screen to be performed on incoming leads may be selected through (for example) a drop-down menu that lists one or more credit bureaus 108 (e.g., TransUnion, Experian). In some embodiments, a user may be permitted to select the credit “buckets” from which the dealer is willing to accept leads from this program (e.g., by selecting one or more credit range checkboxes). The following table provides examples of suitable credit buckets and corresponding scores/meanings.

| Credit Bucket | Credit Score |
|---|---|
| A | 640+ |
| B | 621–640 |
| C | 601–620 |
| D | 581–600 |
| E | 561–580 |
| F | 541–560 |
| G | 521–540 |
| H | 500–520 |
| I | 499 or below |
| J | Fraud |
| K | No Criteria Met |

With respect to demographics augmentation, routing engine 116 may provide an administrator of system 112 with one or more pages (e.g., the aforementioned affiliate administration page) from which affiliate(s) 106 and/or car dealership(s) 104 can be enrolled in real-time marketing (“RTM”). Alternatively or additionally, a user at affiliate 106 and/or car dealership 104 may be authorized to set options related to demographics augmentation via one or more information displays. In some embodiments, the user may be permitted to select real-time marketing settings for each lead type and/or affiliate 106 such that, for example, incoming applications from one or more selected affiliates 106 may have a RTM check performed on them. The user may be permitted to enroll/unenroll the affiliate(s) 106 in the RTM service through the use of one or more selectable options on the page(s). Routing engine 116 may also provide one or more pages (e.g., a program and source page) from which program(s) can be enrolled/unenrolled in the real-time marketing process. For example, checking an RTM box next to a program name may make leads for that program eligible to receive real-time marketing checks.

At stage 212, the lead may be routed electronically to the car dealers selected at stage 208 if it is determined at stage 210 that no credit check and/or demographics augmentation is to be performed on the lead. For example, the credit check and demographics augmentation may be an optional service, and no credit check and/or demographics augmentation may be performed when the service is not subscribed to by one or more of the car dealership(s) selected at stage 208, the affiliate 106 that submitted the lead, and/or the program associated with the lead.

At stage 214, the lead may be subject to a credit check and/or demographics augmentation. For example, the credit check and/or demographics augmentation may be performed if it is determined at stage 210 that at least one (e.g., all) of the car dealership(s) selected at stage 208, the affiliate 106 that submitted the lead, and/or the program associated with the lead is enrolled in the credit check and/or demographics augmentation services. Advantageously, subjecting leads to credit checks and/or demographics information may allow system 112 to charge higher premiums for the leads. In some embodiments, stage 214 may involve transmitting at least a portion of the information for the lead to one or more credit bureau(s) 108.

At stage 216, a result of the credit check and/or demographics augmentation may be received. For example, if information for the party associated with the lead is located in database(s) administered by a credit bureau 108, a credit grade/bucket (e.g., A, B, C, D, etc.) and/or some or all of following demographics data may be provided by credit bureau 108 to system 112: validated address information for the individual, demographic information for the individual, title, surname/suffix, gender, age, birth month/year (e.g., MMYYYY), birth date, marital status, education level, occupation (e.g., by occupation code), an indication of whether the party's household includes (or is likely to include) at least one child, number of children, dwelling type, household income, length of residence, renter status (e.g., yes or no), probable renter status, homeowner status, and home value. However, if no information regarding the party associated with the lead is located (e.g., based on a name matching process and/or reverse phone number lookup), the credit bureau 108 may provide system 112 with an error message for the lead. In response, routing engine 116 may reject the lead and/or send it to a dealership 104 that is not enrolled in the credit check and/or RTM services and therefore does not expect to receive credit and/or demographics information. Examples of error messages that may be received by routing engine 116 from credit bureau(s) 108 may include: CELEB—potential celebrity impersonation, JOKE—joke name, NOTNAME—name is not a valid name, VULGAR—name has vulgar components. In other embodiments, credit bureau(s) 108 may provide the result of the credit check and/or demographics augmentation directly to the car dealership(s) 104 selected at stage 208. For example, system 112 may transmit dealer IDs that identify the selected car dealers to credit bureau(s) 108 as part of stage 214, and credit bureau(s) 108 may use that information to contact the dealers.

At stage 218, a notification may be sent indicating whether the lead is accepted or rejected. For example, in some embodiments, the affiliate 106 that provided the lead to system 112 may agree to maintain a HTTP POST connection with system 112 long enough (e.g., 3 seconds) for system 112 to subject the lead to a credit check and/or demographics augmentation and to return a response (e.g., accept or reject) to the affiliate. In some embodiments, affiliate 106 may not maintain the HTTP POST connection long enough for the required processing, in which case system 112 may send the response to affiliate 106 according to another approach (e.g., e-mail).

At stage 220, the lead may be augmented with the credit grade and/or demographics information and the augmented lead may be provided to the car dealership(s) selected at stage 208. For example, with respect to credit checking, each credit bureau 108 may return a credit grade/bucket for the lead based on the associated party's credit score. If the lead falls within a bucket the dealer(s) will accept, the lead may be sent to the dealer(s). However, if the lead falls within a bucket not acceptable to the dealer(s), system 112 may select new car dealership(s) 104 (e.g., at stage 208) that are not enrolled in the credit check and/or RTM services and the lead (with or without the augmented information) may be submitted to the new car dealers.

The following description provides additional details regarding selecting car dealership(s) (e.g., stage 208) that are eligible to receive a lead in accordance with some embodiments of the present invention. As described in connection with FIG. 1, routing system 112 may store information regarding the preferences/settings for one or more car dealerships 104. For example, for each program in which the car dealer is enrolled, system 112 may store (e.g., in database 118) a daily cap, monthly cap, monthly target, the quantity of leads received by the dealer for that program on the previous day, the quantity of leads received by the dealer for that program on the current day, the quantity of leads received by the dealer for that program for the month to date, the quantity of leads received by the dealer for that program for the previous month, and/or when the dealer's cap(s) and/or target(s) are scheduled to change. For example, to modify a dealer's monthly cap or target for a program, an administrator of system 112 or car dealership 104 may select a schedule/update icon next to that program on a graphical user interface display (e.g., generated by system 112 or CRM tool 124), which may open a scheduling window. To schedule a cap or target change, the administrator may select a date from a graphical calendar window to specify the date for the change. The administrator may enter the desired monthly cap and target, and then select a save option to add the event. This may cause the event to be displayed on a list of scheduled events. To delete a scheduled event, the administrator may check a delete box next to the desired event, and select a save option. At 12:01 AM on the scheduled date (or at some other predetermined time), routing engine 116 may automatically adjust the dealer's monthly cap or target to the selected value.

In some embodiments, routing engine 116 may actively manage the daily caps and/or targets of car dealers. For example, routing engine 116 may attempt to provide each dealer with a number of leads that causes their monthly lead volume to track at 120% of the dealer's monthly cap. Thus, each dealer may have a daily cap that equals 120% of their monthly cap minus the number of leads they have received month-to-date, divided by the remaining days in the month. This daily cap may adjust automatically every day (or according to any other suitable frequency in time) as needed to keep dealers on track to reach their respective caps.

FIG. 3 is a flowchart of illustrative stages involved in adjusting the affiliates from which a car dealership is eligible to receive leads in accordance with an embodiment of the present invention. At stage 302, a set of affiliates (e.g., a default set of affiliates) may be assigned to a car dealership. Once an affiliate has been assigned to a dealership, that dealership may be eligible to receive leads from the affiliate. Affiliates can be assigned (or prevented from being assigned) to a car dealership 104 manually (e.g., on a dealer marketing page accessible to employees of system 112 and/or the dealership 104 via an appropriate interface) and/or automatically by system 112. For example, routing engine 116 may start the dealership 104 each day with a set of affiliates that is based at least in part on a dealer's monthly lead tracking percentage. Routing engine 116 may assign a set of affiliate identifiers to a car dealership, for example, by associating affiliate identifiers with an entry for a car dealership in database 118. At stage 304, at one or more intervals throughout the day it may be determined whether the dealership is on track to meet it's cap or target (e.g., daily cap or target) with the assigned set of affiliates. If the dealership is on track, at stage 306 no change may be made to the assigned set of affiliates. If the dealership is tracking low, at stage 308 one or more affiliates may be added to the set (e.g., added automatically by routing engine 116). If the dealership is tracking high, at stage 310 one or more affiliates may be removed from the set. In some embodiments, routing engine 116 may alternatively or additionally adjust the types of leads (e.g., internet and/or telephonic) and/or programs for which the dealership can receive leads based at least in part on a cap or target for the dealership.

In some embodiments, routing engine 116 may group affiliates within a tier system such as, for example, tier 1=preferred affiliates, also referred to as 100% POST affiliates, tier 2 (additional affiliates), tier 3 (yet additional affiliates), tier 4, tier 5, and so on. Based on the dealer's track percentage (e.g., monthly track percentage), system 112 may toggle affiliate tiers off and on. For example, if a dealership 104 is tracking at 90% or higher for the month, that dealer may be enrolled in tier 1 only. If dealer 104 is tracking between 80%-89.9%, that dealer may be enrolled in tier 1 and tier 2. If dealer 104 is tracking between 70%-79.9%, that dealer may be enrolled in tier 1, tier 2, and tier 3. If dealership 104 is tracking between 60%-69.9%, that dealer may be enrolled in tier 1, tier 2, tier 3, and tier 4. If dealer 104 is tracking between 50%-59.9%, that dealer may be enrolled in tier 1, tier 2, tier 3, tier 4, and tier 5. The dealer's enrollment in the affiliate tiers may be adjusted automatically throughout the day or at any other suitable time or with any other suitable frequency. In some embodiments, all dealers 104 may begin each new month (or other time period) enrolled in tier 1, tier 2, tier 3 and tier 4. An administrator of system 112 and/or dealerships 104 may additionally have the ability to “Lock Out” certain affiliate(s) 106 or tiers of affiliates, for example, in order to handle the exception where a dealership 104 does not want to receive leads from those affiliate(s). If an affiliate 106 is locked out, it may be prevented from being toggled on during the adjustments. In some embodiments, routing engine 116 may allow leads from particular affiliates and/or tiers of affiliates (e.g., tier 1) to cause a dealer 104 to exceed it's cap or target by a predetermined amount (e.g., exceed the daily cap by 20%). Until a dealer 104 reaches it's cap or target, it may be eligible to receive leads from any enrolled affiliate. Once the dealer has exceeded it's cap or target by the predetermined amount, it may not receive any additional leads (e.g., for that day).

In some embodiments, if routing engine 116 receives a lead from (for example) tier 1 affiliate(s) that would be rejected (e.g., all dealerships associated with the relevant zip code are tracking at 120% of their daily caps), routing engine 116 may save the application in memory (e.g., within database 122). Routing engine 116 may then continue to try sending the lead to selected car dealership(s) 104 for 24 hours or other suitable time period. If the application is not sent to a dealer 104 within that time period, routing engine 116 may attempt to send the lead to a third-party reseller.

FIG. 4 is a flowchart of illustrative stages involved in initiating follow-up contacts with customers according to a predetermined, event-driven methodology in accordance with an embodiment of the present invention. At stage 402, a lead for a party may be assigned to a car dealership. For example, as described above, routing engine 116 may select a car dealership 104 and transmit the lead to that dealership over network(s) 114 based at least in part on, for example, affiliate-specific and/or dealer-specific settings stored in databases 118 and 120.

At stage 404, it may be determined whether the car dealership is enrolled in a follow-up service. For example, in some embodiments, the service provided by CRM tool 126 (e.g., FUEL) may be sold as a program enhancement, and may have one or more levels of service that may or may not depend on dealer enrollment. In some embodiments, routing engine 116 and/or CRM tool 126 may provide one or more pages (e.g., a program enrollment page) from which dealer(s) 104 can be enrolled in the FUEL service. At stage 406, no follow-up contacts may be initiated to the party if the car dealership is not enrolled in the follow-up service.

At stage 408, if the car dealership is enrolled in the follow-up service, one or more follow-up contacts may be initiated to the party on behalf of the car dealership according to a predetermined methodology. For example, the page(s) described above for enrolling car dealer(s) in the follow-up service may include a series of checkboxes, drop-down menus, and/or other graphical elements for enabling/disabling the following follow-up contacts: an option enabling dealer enrollment in follow-up physical mail (e.g., for one or more programs, affiliates, or lead types), an option enabling dealer enrollment in follow-up e-mail (e.g., for 30 days after receipt of the lead by system 112), an option enabling the dealer's leads to receive follow-up telephonic contacts (e.g., for 90 days) from a live operator and/or automated system of a business development center (“BDC”) associated with system 112, and/or option(s) for selecting offer(s) for inclusion within final offer correspondence (e.g., a gift card and/or a discount off of the price of a new vehicle). With these and/or other options related to follow-up contacts enabled for the car dealership, follow-up contacts may be initiated automatically at appropriate time(s) and/or in response to events within the sales cycle. In some embodiments, whether or not follow-up contacts are sent to the party may alternatively or additionally depend at least in part on whether the affiliate 106 provider of the lead, the type of lead (e.g., internet or telephonic), and/or the program associated with the lead are enrolled in the follow-up service.

For example, in some embodiments, the service provided by CRM tool 126 may be activated for a given lead only when both the car dealership that received the lead and the program associated with the lead are enrolled in the follow-up service. When active, CRM tool 126 may trigger follow-up contacts (e.g., e-mail messages) when the lead reaches a specified date and/or status within the predetermined methodology. Triggering of the e-mail messages by CRM tool 126 may involve sending the information associated with the lead to server(s) within system 112 or to third-party server(s) (e.g., CheetahMail server(s), which may be part of credit bureau(s) 108) for use in populating an appropriate e-mail template and sending the e-mail message to the party. For example, CRM tool 126 may store e-mail template IDs associated with different follow-up e-mails (e.g., “Please schedule an appointment”, “Thank you for your purchase”, etc.). These e-mail template IDs may be associated in memory with event IDs corresponding to events in the predetermined methodology, such that an appropriate e-mail template is selected and used when the corresponding event occurs in the methodology. CRM tool 126 may submit one or more e-mail template IDs and other information (e.g., information regarding the party and/or car dealership) to the one or more servers. Such information may include: lead ID, lead program, lead date of submission, last name, first name, middle name, name suffix, street number, street name, street type code, address2, city, state, zip, zip+4, zip4, vehicle year, vehicle brand, vehicle make, vehicle model, dealer ID, dealership name, dealer address 1, dealer address2, dealer city, dealer state, dealer zip, dealer phone, dealer contact, promotion information, and/or final offer information. In some embodiments, the text of the e-mails may include a call to action for customers to contact the dealer or BDC.

In some embodiments, system 100 may provide customers of car dealership(s) 104 with opportunities to schedule in-person appointments with the car dealers. For example, clicking a link in an e-mail triggered by CRM tool 126 may redirect a customer to a “Set Appointment” page (e.g., generated by CRM tool 126 or routing engine 116), from which the customer can select a date on a calendar and an appointment time from a drop-down menu. In some embodiments, the system only allows customers to set appointments during available dates and/or times (e.g., for a selected dealer 104), which may be based on dealer-specific or default information stored in database 118. For example, the system may check the schedule for the dealership employee that has been assigned the lead, which information may be received by CRM tool 126 from CRM tool 124. If no employee has been assigned the lead, the system may check the availability for a primary contact at the dealership. If the primary contact does not have a schedule, the system may base the availability of the dealer on a default schedule (e.g., Monday-Saturday: 9 AM-6 PM). System 112 may maintain (e.g., in database 118) records of all appointments that have been scheduled with car dealership(s) 104 to prevent conflicts with future appointments. In some embodiments, the Set Appointment page may display the address and phone number of the dealership where the customer's appointment is scheduled. The page may also include a link that can be selected by the customer in order to receive directions to the dealership. In some embodiments, the page may include a “Comments/Questions” box through which the customer can provide comments or questions about their application or appointment. Once the customer has selected a date and time and entered any comments, the customer set the appointment with the selected dealer 104 by selecting a “Set Appointment” option.

At stage 410, the car dealership may be notified of the follow-up contact(s). For example, CRM tool 126 may send a notification to CRM tool 124 each time CRM tool 126 triggers a follow-up contact to the party associated with the lead. CRM tool 124 may display information identifying the follow-up contact(s) to users at car dealership 104 in one or more information displays (e.g., in a contacts page and/or history page). In some embodiments, information regarding scheduled appointments may also be displayed in the one or more information displays generated by CRM tool 124.

At stage 412, information may be received that identifies a change in status of the lead, which in turn adjusts the lead's position within the sequence of follow-up contacts to be initiated to the party. For example, an employee of car dealership 104 may provide CRM tool 124 with information identifying that the party associated with the lead has completed the purchase of an automobile. CRM tool 124 may then notify CRM tool 126 of the update. In response, CRM tool 126 may change the lead's status from a first status (e.g., lead received 2 days ago) to a second status (e.g., purchase complete). Based at least in part on the status change, CRM tool 126 may trigger an appropriate follow-up contact (e.g., stage 408), if any such follow-up contact is associated with the second status (e.g., a “Thank you for your purchase” e-mail).

Thus it is seen that systems and methods are provided for routing loan application information electronically and for managing relationships with customers. Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device, electronic, optical or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A system for processing loan application information electronically, comprising:
a routing engine configured to:
receive a lead electronically, wherein the lead comprises information relating to a party seeking to purchase an automobile with a loan;
submit at least a portion of the information from the lead to a credit checking system for a credit check;
receive credit information regarding the party in response to the submitting; and
based at least in part on the credit information, route the lead to a selected destination.

2. The system of claim 1, wherein the credit check comprises a soft credit check.

3. The system of claim 1, wherein the routing engine is configured to submit at least a portion of the information from the lead to a credit checking system in substantially real time.

4. The system of claim 1, wherein the routing engine is configured to receive the lead via a HyperText Transfer Protocol (“HTTP”) connection with an affiliate.

5. The system of claim 4, wherein the routing engine is further configured to:
determine whether to accept or reject the lead based at least in part on the credit information; and
submit a response to the affiliate regarding the determination.

6. The system of claim 5, wherein the routing engine is configured to submit the response to the affiliate via the same HTTP connection with the affiliate.

7. The system of claim 1, wherein the routing engine is configured to:
provide a Secure Socket Layer (“SSL”) post page; and
receive the lead via posting of an extensible markup language (“XML”) document to the post page.

8. The system of claim 1, wherein said credit information comprises a credit grade representative a range of credit scores.

9. The system of claim 1, further comprising a database comprising information regarding multiple car dealerships, wherein the routing engine is configured to:
select a car dealership from the database; and
based at least in part on the credit information, determine whether to submit the lead to the selected car dealership.

10. The system of claim 9, wherein:
the lead comprises a zip code;
the database comprises associations between the multiple car dealerships and zip codes; and
the routing engine is configured to select the car dealership from the database based at least in part on a comparison between the zip code of the lead and the zip codes stored in the database.

11. The system of claim 9, wherein the routing engine is further configured to:
assign a set of one or more affiliate identifiers to each of the car dealerships, where each affiliate identifier is associated with an affiliate from which leads can be received;
determine whether each dealership is on track to meet a lead cap or target;
depending on the outcome of the determination, automatically adjust the sets of affiliate identifiers for the car dealerships;
receive an affiliate identifier associated with the lead; and
select the car dealership from the database based at least in part on a match between the affiliate identifier associated with the lead and the set of one or more affiliate identifiers assigned to the car dealership.

12. A system for processing leads electronically, comprising:
a routing engine configured to:
receive a lead electronically, wherein the lead comprises information relating to a party seeking to purchase an automobile;
submit a request for demographics information relating to the party;
receive the demographics information in response to the submitted request;
augment the lead with at least a portion of the received demographics information; and
route the augmented lead to a relevant destination.

13. The system of claim 12, further comprising a database comprising associations between multiple car dealerships and zip codes, wherein:
the lead comprises a zip code; and
the routing engine is configured to select the car dealership from the database based at least in part on a comparison between the zip code of the lead and the zip codes stored in the database.

14. The system of claim 12, wherein the demographics information is selected from the group consisting of title, surname, gender, age, birth date, marital status, education level, occupation code, number of children, dwelling type, household income, length of residence, renter status, homeowner status, home value, and a combination thereof.

15. A system for managing follow-up contacts with customers, comprising:
a database comprising associations between events within a sales cycle and follow-up contacts; and
a customer relationship management tool configured to:
receive information identifying a customer of a car dealership and a status of that customer; and
when the customer's status matches an event within the sales cycle, trigger a follow-up contact to the customer on behalf of the car dealership.

16. The system of claim 15, wherein the customer relationship management tool is implemented remotely from the car dealership.

17. The system of claim 15, wherein the customer relationship management tool is configured to trigger multiple follow-up contacts automatically according to a predetermined methodology.

18. The system of claim 15, wherein the customer relationship management tool is configured to:
receive an update with respect to the status of the customer;
change the customer's status from a first status to a second status, wherein the second status is associated with an event in the sales cycle; and
trigger a follow-up contact associated with the second status to the party.

19. The system of claim 15, wherein the customer relationship management tool is configured to trigger the sending of an e-mail to the party.

20. The system of claim 15, wherein the customer relationship management tool is configured to trigger the mailing of physical mail to the party.

21. The system of claim 15, wherein the customer relationship management tool is configured to trigger the placement of a telephone call to the party.

22. A method for processing loan application information electronically, comprising:
receiving a lead electronically, wherein the lead comprises information relating to a party seeking to purchase an automobile with a loan;
submitting at least a portion of said information from the lead for a credit check;
receiving credit information regarding the party in response to the submitting; and
based at least in part on the credit information, routing the lead to a selected destination.

23. The method of claim 22, wherein submitting at least a portion of the information from the lead for a credit check comprises submitting at least a portion of the information from the lead for a soft credit check.

24. The method of claim 22, wherein submitting at least a portion of the information from the lead for a credit check comprises submitting at least a portion of the information from the lead for a credit check in substantially real time.

25. The method of claim 22, wherein receiving a lead electronically comprises receiving the lead via a HyperText Transfer Protocol (“HTTP”) connection with an affiliate.

26. The method of claim 25, further comprising:
determining whether to accept or reject the lead based at least in part on the credit information; and
submitting a response to the affiliate regarding the determination.

27. The method of claim 26, wherein submitting a response to the affiliate comprises submitting the response via the same HTTP connection with the affiliate.

28. The method of claim 22, further comprising:
providing a Secure Socket Layer (“SSL”) post page; and
receiving the lead via posting of an extensible markup language (“XML”) document to the post page.

29. The method of claim 22, further comprising:
storing information regarding multiple car dealerships;
selecting a car dealership from the multiple car dealerships; and
based at least in part on the credit information, determining whether to submit the lead to the selected car dealership.

30. The method of claim 29, wherein:
storing information regarding multiple car dealerships comprises storing associations between the multiple car dealerships and zip codes; and
selecting a car dealership comprises selecting the car dealership based at least in part on a comparison between a zip code of the lead and the stored zip codes.

31. The method of claim 29, further comprising:
assigning a set of one or more affiliate identifiers to each of the car dealerships, where each affiliate identifier is associated with an affiliate from which leads can be received;
determining whether each dealership is on track to meet a lead cap or target;
depending on the outcome of the determination, automatically adjusting the sets of affiliate identifiers for the car dealerships;
receiving an affiliate identifier associated with the lead; and
selecting the car dealership from the database based at least in part on a match between the affiliate identifier associated with the lead and the set of one or more affiliate identifiers assigned to the car dealership.

32. A method for processing leads electronically, comprising:
receiving a lead electronically, wherein the lead comprises information relating to a party seeking to purchase an automobile;
submitting a request for demographics information relating to the party;
receiving the demographics information in response to the submitted request;
augmenting the lead with at least a portion of the received demographics information; and
routing the augmented lead to a relevant destination.

33. A method for managing follow-up contacts with customers, comprising:
storing associations between events within a sales cycle and follow-up contacts;
receiving information identifying a customer of a car dealership and a status of that customer; and
when the customer's status matches an event within the sales cycle, triggering a follow-up contact to the customer on behalf of the car dealership.

34. The method of claim 33, further comprising triggering multiple follow-up contacts to the party automatically according to a predetermined methodology.

35. The method of claim 33, further comprising:
receiving an update with respect to the status of the customer;
changing the customer's status from a first status to a second status, wherein the second status is associated with an event in the sales cycle; and
triggering a follow-up contact associated with the second status to the party.

36. A computer-readable medium comprising computer program logic encoded thereon for performing the method comprising:
receiving a lead electronically, wherein the lead comprises information relating to a party seeking to purchase an automobile with a loan;
submitting at least a portion of said information from the lead for a credit check;
receiving credit information regarding the party in response to the submitting; and
based at least in part on the credit information, routing the lead to a selected destination.

37. A system for processing leads electronically, comprising:
at least one database comprising information regarding multiple car dealerships;
a server for receiving a extensible markup language (“XML”) document electronically via a Secure Socket Layer (“SSL”) post page, wherein the XML document comprises information relating to a party seeking to purchase an automobile; and
a processor in communication with the server and the at least one database for submitting, over a network, at least a portion of the information from the XML document to a system for at least one of a credit check and a demographics check, for augmenting at least a portion of the information from the XML document with information received in response to the submission, and for routing the augmented information to a car dealership selected based at least in part on a comparison between the information stored in the at least one database and the information from the XML document.

38. The system of claim 37, further comprising a customer relationship management tool in communication with the processor for receiving information from the processor regarding the party and the selected car dealership, and for triggering follow-up contacts to the party on behalf of the car dealership according to a predetermined, event-driven methodology.

39. The system of claim 37, wherein:
the at least one database further comprises lead tracking data for the car dealerships, information regarding multiple affiliates capable of posting XML documents to the SSL post page, and assignments of sets of affiliates to car dealerships, wherein an assignment of an affiliate to a car dealership renders that car dealership eligible to receive leads from that affiliate; and
the processor adjusts automatically for each car dealership the set of affiliates from which the car dealership is eligible to receive leads based at least in part on the lead tracking data for the car dealership.

40. A system for processing leads electronically, comprising:
means for receiving a lead electronically, wherein the lead comprises information relating to a party seeking to purchase an automobile;
means for submitting at least a portion of said information from the lead for at least one of a credit check and a demographics check;
means for receiving at least one of credit information and demographics information regarding the party in response to the submitting;
means for augmenting the lead with the at least one of credit information and demographics information; and
means for routing the augmented lead to a relevant destination.
